(19) United States
(12) Patent Application Publication
(10) Pub. No.: US 2010/0314839 A1
(43) Pub. Date: Dec. 16, 2010

(54) REPLACEABLE WATER TIGHT SEAL

(76) Inventor: RUDO ENSERINK, Rotterdam (NL)

Correspondence Address: J. GORDON THOMSON, P.O. BOX 8865, VICTORIA, BC, V8V 3Z1, CA

(21) Appl. No.: 12/485,024

(22) Filed: Jun. 15, 2009

(51) Int. Cl. F16J 15/02

(52) U.S. Cl. 277/630

(57) ABSTRACT

A flexible seal for sealing various garments of a diving suit having a flexible first element comprising a sealing chamber and a flexible second element comprising a sealing head. In a preferred embodiment, the second element is made from flexible material that is harder than the material of the first element. The sealing head further comprises a series of parallel and linear spines protruding from the circumference thereof. When the sealing head is inserted into the sealing chamber the spines press against the softer inside wall of the sealing chamber thereby providing a plurality of redundant seals. Anchor means is provided to resist tension in the seal caused by pulling the two elements apart. Independent locking means is provided in the form of a plurality of locking posts and loops.

### FIELD OF THE INVENTION

This invention concerns means to create replaceable, water impervious and detachable seals between a first item and a second item.

### BACKGROUND OF THE INVENTION

The importance of having a completely sealed diving suit is well known. Underwater, even slight leaks into a diving suit can have fatal consequences for a diver. Another important reason for having replaceable seals in a diving suit between wrist and glove, boot and ankle and cap and neck is that there are various types and sizes of suits in the market. The replaceable seal facilitates replacement of any of these items as they wear out without having to discard the entire item. There are a variety of seals known in the field of sport, military and commercial diving, however, these seals are often plagued by the same problems. One such problem is that the seals cannot resist tension. They may close completely and remain water tight under most circumstances, but in situations where the seal is pulled it leaks and may open. Another problem is created by the flexible materials that diving garments and seals are made from. This flexibility is well suited to adapting to human movement underwater but a lack of rigidity makes the creation of a sure water seal almost impossible. Finally, seals are permanently fixed to the garment parts. They will, in time, wear out. Worn seals cannot be replaced on a suit and the only recourse is to discard the worn suit and purchase a new one. This leads to great expense.

Therefore, there is a requirement for a seal, such as those used to join diving suit garments, to remain water impervious under loads, be flexible and be replaceable.

### SUMMARY OF THE INVENTION

In accordance with the present invention a replaceable water tight radial seal for the detachable sealing of a diving suit first garment to a diving suit second garment comprises a first element having a sealing chamber comprising a tensionable wall membrane and a second element having a sealing head. The first element is made from a first flexible and water impervious material and it is fixed to the first garment. The sealing chamber is adapted for mating with the second element sealing head. The sealing head has a plurality of linear and parallel spines protruding from its surface. The second element is made from a harder second flexible and water impervious material in order to make the linear and parallel spines and the locking posts (more fully explained below) rigid. The first element sealing chamber is slightly under-dimensioned with respect to the second element sealing head. This necessitates tensioning the first element sealing chamber wall membrane over the second element sealing head. When the second element sealing head mates with the first element sealing chamber, the tips of the second element spines push into the softer membrane thereby forming a plurality of water impervious seal lines around the seal.

The invention further comprises means for locking said seals in a water impervious configuration. The locking means comprises a plurality of locking posts and locking loops. The loops are adapted for tensioned placement around the locking posts. The invention further comprises means for absorbing tension between the first element and the second element caused by movement between the first garment and the second garment. The means for absorbing tension comprises a top and bottom anchor lug fitted into a top and bottom anchor chamber. The locking posts hold the locking loops down to create leverage to hold the anchor lugs within their respective anchor chambers.

One novelty of the invention is that the means for absorbing tension, the water impervious seals and the means for locking operate independently.

### Objects and Advantages

According, besides the objects and advantages of the seal described above, several objects and advantages of the invention are:
a. To provide a water impervious seal that can resist pulling loads;
b. To provide a water impervious seal that has inherent seal redundancy;
c. To provide a water impervious seal that can replace existing seals between the various garments of a diving suit;
d. To provide a comfortable and flexible seal for the diver; and,
e. To provide a water impervious seal that is compact, reliable and provides feedback to the diver as to proper installation.

Still further objects and advantages will become apparent from a consideration of the ensuing description and drawings.

### DESCRIPTION OF THE FIGURES

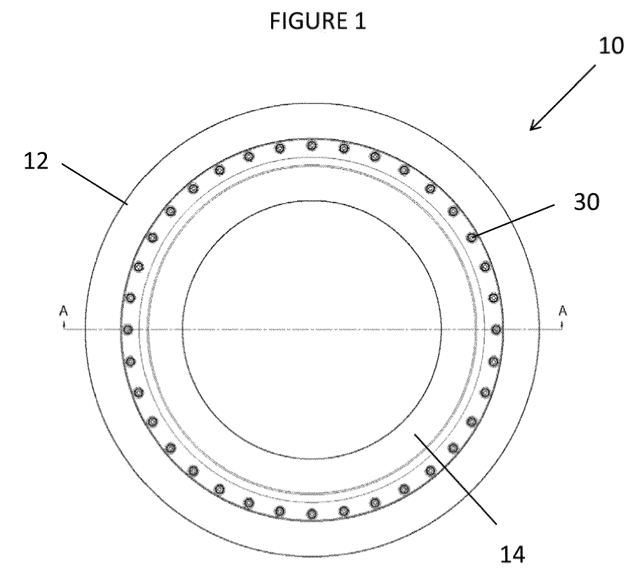

1. FIG. 1 is a top view of one embodiment of the invention.

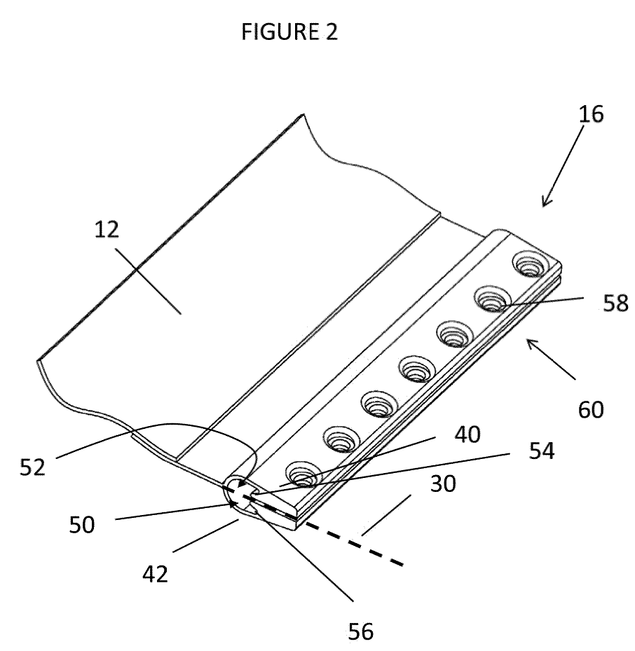

2. FIG. 2 is a top perspective view of a first element of one embodiment of the invention.

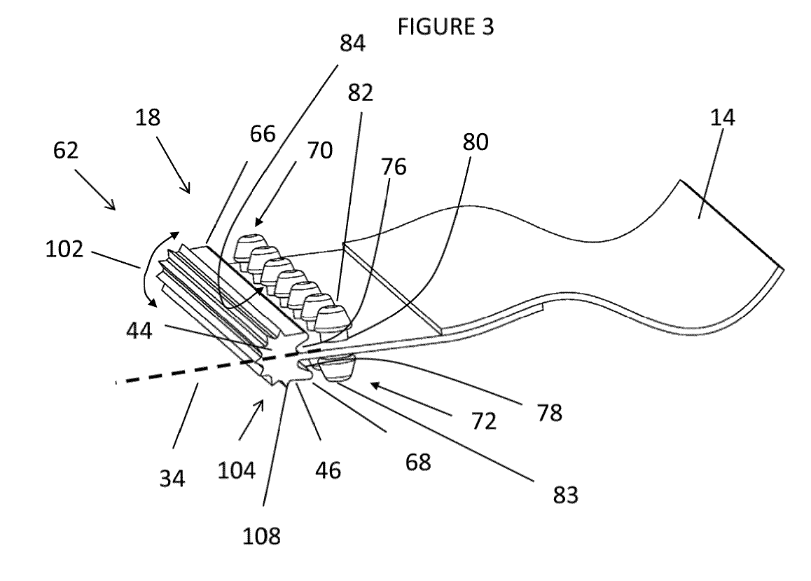

3. FIG. 3 is a side perspective view of a second element of one embodiment of the invention

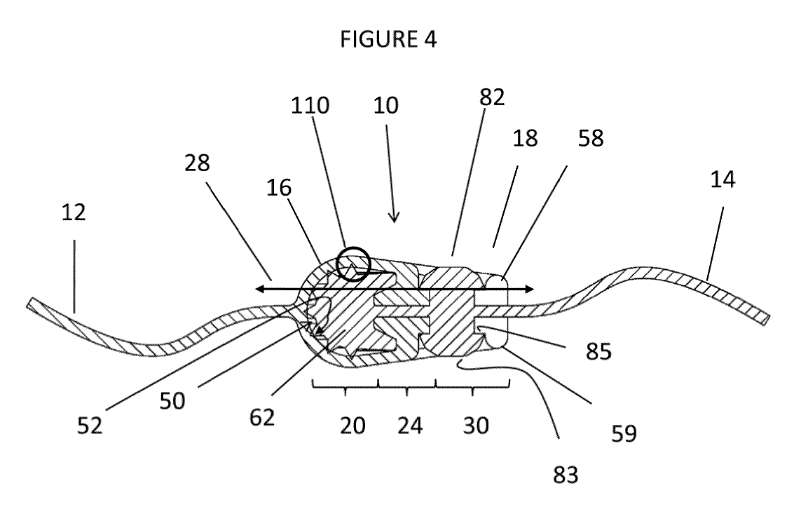

4. FIG. 4 is a side view of a seal of one embodiment of the invention.

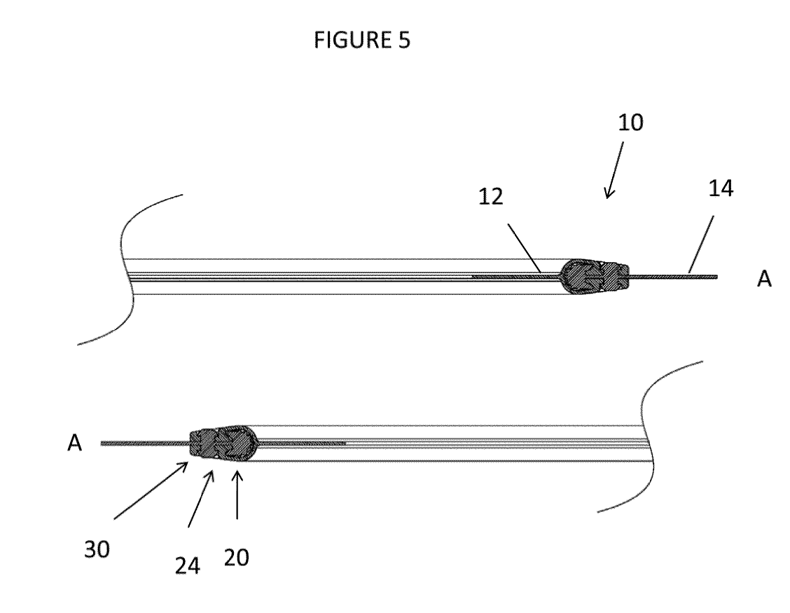

5. FIG. 5 is a side view of a cross section A-A across FIG. 1.

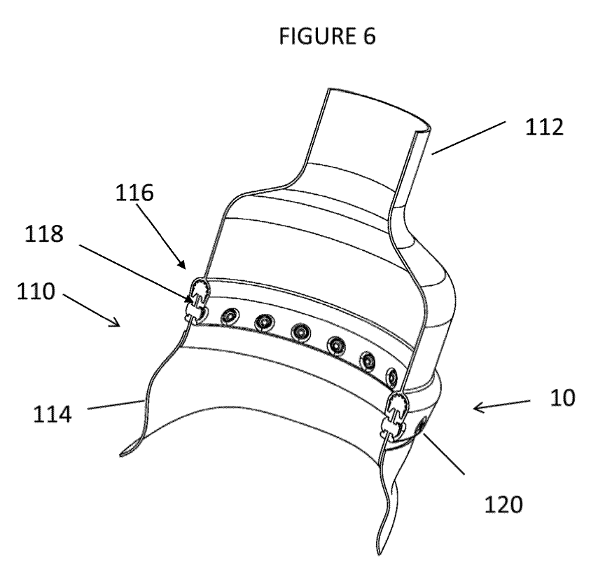

6. FIG. 6 is another embodiment of the invention.

### DETAILED DESCRIPTION

Referring to FIG. 1, there is shown a top view of one preferred embodiment of the invention which is a replaceable water tight radial seal 10 for the detachable sealing of a diving suit first garment 12 to a diving suit second garment 14. In the embodiment shown the garment is a diving suit neck collar. The first and second garments can be, respectively, a glove and sleeve, a boot and pant leg, trousers and jacket or hood and jacket. So the seal can be used as a neck seal, wrist seal, boot seal and torso seal. As well the seal can be used in any application where a water impervious seal is necessary between two flexible materials.

Referring to FIG. 2, the water tight radial seal comprises a first element 16 fixed to the first garment 12.

Referring to FIG. 3, the water tight radial seal further comprises a second element 18 fixed to the second garment 14.

Referring to FIG. 4, when fastening the first garment 12 to the second garment 14 the first element 16 and the second element 18 join in a cooperative relationship to form radial seal 10 having sealing means comprising portion 20 for creating a water impervious relationship between the first garment and the second garment, means for absorbing tension comprising portion 22 for absorbing tension 24 in the radial seal 10 caused by movement between the first garment and the second garment and locking means comprising portion 26 for locking the sealing means 20 in the water impervious configuration and for locking the first garment 12 to the second garment 14.

The means for absorbing tension, the sealing means and the locking means operate independently, that is none of these functions are combined into a single element. Independence and separation creates stronger and more reliable individual functions. This separation also allows for positioning of the locking means elements, that is, the locking posts and the locking loops, to act in a direction perpendicular to the pulling force between the two elements.

Referring again to FIG. 4, the means for absorbing tension 22 is operatively located between the sealing means 20 and the locking means 26.

Referring to FIG. 1 and FIG. 5, there is shown in FIG. 1 a top view of the seal 10 between a first garment 12 and a second garment 14. FIG. 5 shows side cross sectional view A-A in FIG. 1. FIG. 5 illustrates that the sealing means 20 and the means for absorbing tension 22 are continuous around the circumference of the seal 10. However, the locking means 26 comprises a plurality of evenly spaced locking elements 30 disposed around the seal 10. The number of locking elements 30 is sufficient to safely resist tensions in the seal 10 between the first 12 and second 14 garments caused by motion of the wearer.

The first element 16 is made from a first flexible and water impervious material and the second element 18 is made from a second flexible and water impervious material. These materials are common materials well known and used in the art of diving suit manufacture.

In a preferred embodiment, the second flexible and water impervious material is harder than the first flexible and water impervious material. In other words, when these materials are in contact with each other, the first material will have a tendency to yield to the second material.

Referring to FIG. 2 and FIG. 3, the first element 16 has a first element horizontal axis 30 and the first garment 12 has a first garment horizontal axis 32. The first element is fixed co-axially to the first garment. The second element 1 8 has a second element horizontal axis 34 and the second garment 14 has a second garment horizontal axis 36. The second element is fixed co-axially to the second garment.

Referring to FIG. 2, the first element 16 comprises a first element top portion 40 and a symmetrical first element bottom portion 42 disposed in a mirrored relationship across the first element horizontal axis 30.

Referring to FIG. 3, the second element 18 comprises a second element top portion 44 and a symmetrical second element bottom portion 46 disposed in a mirrored relationship across the second element horizontal axis 34.

As illustrated in FIG. 2, the first element top portion 40 and the first element bottom portion 42 combine to form a semi-circular sealing chamber 50 having a concave inside surface 52. The chamber 50 is continuous around the circumference of the seal 10. There is also a top anchor member 54 and a bottom anchor member 56 which are also continuous around the seal 10. The first element also includes a plurality of top 58 and bottom 60 locking loops evenly spaced around the seal.

Referring now to FIG. 3, the second element top portion 44 and the second element bottom portion 46 combine to form the second element 18 which is a member comprising an outside portion comprising a semi-circular sealing head 62 which is continuous around the seal 10 and an inside portion 64 comprising a top 66 and a bottom 68 inwardly disposed lug. The second element further comprises plurality of top 70 and bottom 72 perpendicular projecting locking posts disposed around the seal. Between the top 70 and bottom 72 locking posts and the top 66 and bottom 68 inwardly projecting lugs are a top 76 and a bottom 78 anchor cavity. The anchor cavities are continuous around the seal. Each one of the top and bottom projecting locking posts comprises a locking post stem 80 and 81, a locking post head 82 and 83, and a locking post flange 84 and 85. The top anchor cavity 76 and the bottom anchor cavity 78 comprise a cavity toe 86 and 88 under the top and bottom inward projecting lugs and a cavity heel 90 and 92 under the top and bottom locking post flanges.

Still referring to FIG. 3, the semi-circular sealing head outside portion 62 has a circumference 102 and a plurality of continuous linear and parallel spines 104 disposed radial around the circumference. Each spine 104 has a raised tri-angular cross-section 106 and a pointed apex 108 projecting perpendicular to the semi-circular sealing head outside portion 62.

Referring to FIGS. 2, 3 and 4, inserting the semi-circular sealing head outside portion 62 into the semi-circular sealing chamber 50 forms the sealing means further comprising the apex 108 of each of the plurality of continuous spines 104 penetrating the softer inside surface 52 of the semi-circular sealing chamber thereby forming a plurality of redundant water impervious seals 110 within the sealing chamber. The sealing chamber 50 is dimensioned so that it is under-sized to receive the sealing head. This means that there is tension required in the inside diameter of the sealing chamber in order to receive the complete sealing head. This promotes the penetration of the spines into the sealing chamber inside surface.

Still referring to FIGS. 2, 3 and 4, the action of inserting sealing head 62 of element 18 within the sealing chamber 50 of element 16 is followed by the action of inserting top anchor lug 54 into anchor cavity 76 and bottom anchor lug 56 into anchor cavity 78. This forms the load absorbing means referred to as 24 which resists the loads between the elements caused by movement of garment 12 with respect to garment 14. Any pulling along the axes 30 and 32 will be resisted.

Still referring to FIGS. 2, 3 and 4 the locking means is formed by placing the plurality of top 58 and bottom 59 locking loops over the plurality of top 82 and bottom 83 locking posts and under the top 84 and bottom 85 locking post flanges. The locking loops seat underneath the flanges and therefore prevent the loops releasing.

Referring to FIG. 6, there is shown another application of the invention. This Figure illustrates the sleeve of a diving suite 110 comprising a top garment 112 that might be attached to a glove and a bottom garment 114 that might be attached to an arm sleeve. The water impervious seal 116 of the invention 10 is located between the two garments and is locked into place by locking means 118. Anchor means 120 absorb tension between the glove and the sleeve.

From the above description, a number of advantages of the invention become evident:
a. The mating of the sealing head inside the sealing chamber creates a plurality of redundant water impervious seals;
b. Any loads across the seal will be countered by the anchor lugs in their respective anchor chambers;
c. Providing independent locking means creates greater confidence in the seal and anchor because they are not performing locking tasks as well as respective sealing and anchor tasks;
d. Separated sealing, anchoring and locking functions are positioned in such a way as to drastically improve overall reliability of the seal; and,
e. The seal of the invention can be used to replace any worn-out seal oil a diving garment.

Accordingly, the reader will see that the seal of this invention can be used on a variety of garments where there is a need for a water impervious seal. The seal of this invention is easy to operate, reliable and provides tactile feedback to the diver if the sealing head is not property seated in the sealing chamber. Locking means can be visually inspected to ensure that all locking posts are fastened by the locking loops.

Although the description above contains many specifics, these should not be construed as limiting the scope of the invention but as merely providing illustrations of some of the presently preferred embodiments of this invention. For example, the invention can be used in other applications besides diving suits. Thus the scope of the invention should be determined by the appended claims and their legal equivalents, rather than be the examples given.

What is claimed is:

1. A replaceable water tight seal for the detachable sealing of a first item to a second item, said water tight seal comprising a first element fixed to said first item, said first element having a sealing chamber and comprising a first flexible and water impervious material, said sealing chamber adapted for mating with a second element fixed to said second item, said second element comprising a sealing head comprising a second flexible and water impervious material, so that when the second element sealing head mates with the first element sealing chamber and abuts the first material a redundant water impervious seal is formed.

2. The seal of claim 1, wherein the second element sealing head comprises a plurality of spines protruding there from so that when the second element sealing head mates with the first element sealing chamber, said plurality of spines abut the first material thereby forming a plurality of redundant water impervious seals.

3. The seal of claim 2, wherein said first flexible and water impervious material is softer than said second flexible and water impervious material so that when the second element sealing head mates with first element sealing chamber, the plurality of spines push into the first flexible and water impervious material thereby forming a plurality of water impervious seals.

4. The seal of claim 1, further comprising means for causing said seal to lock in a water impervious configuration.

5. The seal of claim 4, further comprising means for absorbing tension between the first element and the second element caused by movement between the first item and the second item.

6. The seal of claim 5, wherein said means for absorbing tension, said plurality of redundant water impervious seals and said means for locking the seal operate independently.

7. The seal of claim 6, wherein the means for absorbing tension is operatively located between the plurality of redundant water impervious seals and the means for locking the seal.

8. The seal of claim 7, wherein the sealing chamber and sealing head are continuous around the seal.

9. The seal of claim 8, wherein the means for absorbing tension is continuous around the seal.

10. The seal of claim 9, wherein the means for locking the seal comprises a plurality of evenly spaced locking elements disposed around the seal.

11. A replaceable water tight seal for the detachable sealing of a first item to a second item, said water tight seal comprising a first element having a first element horizontal axis and fixed to said first item and a second element having a second element horizontal axis and cooperative with said first element fixed to said second item so that when the first element is joined to said second element said seal is formed creating a water impervious relationship between the first item and the second item, means for locking said sealing means in said water impervious configuration and means for absorbing tension between the first element and the second element caused by movement between the first item and the second item, wherein said means for absorbing tension is operatively located between the sealing means and the locking means, and wherein the sealing means, the locking means and said means for absorbing axial tension operate independent from each other.

12. The seal of claim 11, wherein the first element is made from a first flexible and water impervious material and the second element is made from a second flexible and water impervious material.

13. The seal of claim 12, wherein said first material is harder than said second material.

14. The seal of claim 13, wherein the first element comprises a first element top portion and a symmetrical first element bottom portion disposed in a mirrored relationship across said first element horizontal axis.

15. The seal of claim 14, wherein the second element comprises a second element top portion and a symmetrical second element bottom portion disposed in a mirrored relationship across said second element horizontal axis.

16. The seal of claim 15, wherein said first element top portion and said first element bottom portion combine to form a semi-circular sealing chamber having an inside membrane surface and being continuous around the seal, a top anchor member continuous around the seal and a bottom anchor member continuous around the seal and a plurality of top and bottom locking loops evenly spaced around the seal.

17. The seal of claim 16, wherein said second element top portion and said second element bottom portion combine to form a member comprising a semi-circular sealing head, a top and a bottom inwardly disposed anchor lug, a plurality of top and bottom perpendicular projecting locking posts disposed radial around the seal, a top and a bottom anchor cavity continuous around the seal wherein said top and bottom anchor cavities are disposed between the semi-circular sealing head and said plurality of top and bottom locking posts respectively.

18. The seal of claim 17, wherein each one of said projecting locking posts comprises a locking post stem, a locking post head and a locking post flange.

19. The seal of claim 18, wherein said semi-circular sealing head further comprises a top portion having a circumference and a plurality of continuous spines disposed radial around said circumference.

20. The seal of claim 19, wherein each spine of said plurality of continuous spines has a raised tri-angular cross-section and an apex projecting perpendicular to the semi-circular sealing head so that inserting the semi-circular sealing head into the semi-circular sealing chamber forms the sealing means further comprising said apex of said raised tri-angle of the plurality of continuous spines pushing against said softer inside membrane of the semi-circular sealing chamber thereby forming a plurality of water impervious seals within the sealing chamber.

21. The seal of claim 20, whereby inserting said top anchor member into said top anchor cavity and said bottom anchor member into said bottom anchor cavity forms the means for resisting axial tension.

22. The seal of claim 21, wherein the locking means is formed by placing said plurality of top and bottom locking loops over the plurality of top and bottom locking posts and under said top and bottom locking post flange.
